(19) United States
(12) Patent Application Publication
(10) Pub. No.: US 2024/0278272 A1
(43) Pub. Date: Aug. 22, 2024

(54) CORRECTABLE PRESS PUMP

(71) Applicant: Yaowu DING, Taixing (CN)

(72) Inventor: Yaowu DING, Taixing (CN)

(21) Appl. No.: 18/558,205

(22) PCT Filed: Feb. 21, 2022
(86) PCT No.: PCT/CN2022/077049

§ 371 Date: Oct. 31, 2023

(30) Foreign Application Priority Data
May 7, 2021 (CN) 2022110494340.4

(51) Int. Cl. B05B 11/10

(52) U.S. Cl. CPC B05B 11/1077; B05B 11/1001; B05B 11/1074

(57) ABSTRACT

A pressing pump, comprising a pressing head, a tooth sleeve and an air cylinder, wherein the tooth sleeve is connected together with the air cylinder, a piston rod is connected below the pressing head, and a piston is mounted on the piston rod, and the part of the piston rod comprising the piston extends into the interior of the air cylinder. The side peripheral wall of the pressing head cooperates with the side peripheral wall of the tooth sleeve to form a reset mechanism accommodating chamber. The reset mechanism accommodating chamber accommodates an elastic reset mechanism, and the elastic reset mechanism is supported between the pressing head and the tooth sleeve and is arranged around the piston rod.

### TECHNICAL FIELD

This application relates to a press pump for pumping products, more specifically relates to structural design for an elastic reset mechanism in the press pump.

### BACKGROUND

Press pump is broadly used in the field such as cosmetics products (for example shower gel, liquid soap, shampoo, etc.), so as to pump products out from the container containing the product for use. A primary portion of the press pump is made of elastic, and an elastic reset mechanism is provided therein for resetting the press pump. In the conventional press pump of the prior art, elastic reset mechanism is generally metal spring. Metal spring has negative effect on recycling of the press pump. Specifically, because the press pump is an assembly including metal parts and elastic parts, it is to be detached during recycle, which will cause difficulty in recycling the press pump.

In order to improve efficiency of recycling the press pump, it is proposed to manufacture the elastic reset mechanism by plastic instead of a metal spring. The press pump including elastic spring can be totally made of plastic, which may facilitate in recycling the press pump.

During use of the press pump with elastic reset mechanism made of plastic, it is found that the elastic reset mechanism made of plastic may face such problem as twist, deflection and the like, in the process of being pressed. Once it is twisted and/or deflected, there will be loss in resilience of the elastic reset mechanism, causing deterioration of the reset ability of the press pump, and even worse, such twist and/or deflection will cause permanent destroy of the elastic reset mechanism, thus the press pump will lost its reset function.

So, in the field of press pump, there is need to further improve the structure of the press pump, in order to overcome the above mentioned technical problem existing in the prior art.

### SUMMARY

The present invention is made for overcoming the existing problems in the prior art mentioned above. The object of the present invention is to provide a press pump with improved structure, which has the ability of correcting twist and/or deflection of the elastic reset mechanism, so as to improve converting efficiency of resilience of the elastic reset mechanism, and also can prolong service life of the press pump.

The press pump of the present invention includes a press head, a toothed sleeve and a cylinder, wherein a piston rod is connected below the press head and a piston is mounted on the piston rod, the portion of the piston rod including the piston extending into interior of the cylinder. Wherein, a lateral circumferential wall of the press head cooperates with a lateral circumferential wall of the toothed sleeve to form a reset mechanism containing cavity, in which an elastic reset mechanism is contained, the elastic reset mechanism is supported between the press head and the toothed sleeve, and is provided around the piston rod. The elastic reset mechanism includes at least two elastic strips, which are provided so that each elastic strip is located in close proximity to the piston rod; when the elastic reset mechanism is pressed to deform, in case that the elastic reset mechanism is not twisted or deflected, each elastic strip is elastically deformed in their respective deformation plane; and in case that the elastic reset mechanism is not twisted or deflected, the elastic strips are always free of contacting with inner wall of the reset mechanism containing cavity, at least prior to when the press head is pressed to its lower dead center of the stroke.

With the press pump of the above mentioned structure, specifically by means of the provision of the structure and size of the elastic reset mechanism, converting efficiency of resilience during the process of pressing the same can be improved, and the structure enables an automatic correction for the twist or deflection caused from non-uniform in structure, force and the like when being pressed. Specifically, if there is no twist or deflection, the elastic strips will maintain deforming in one deformation plane, and will not contact with the inner wall of the reset mechanism cavity in the whole pressing stroke till the lower dead center, or only contacts with the inner wall just when reaching the lower dead center. Thereby, in the process of being pressed down, if the elastic strips are twisted or deflected, space for correcting and restoring the elastic strips are left in the reset mechanism containing cavity, thus the elastic strips can be corrected. Therefore, resilience loss caused by twist or deflection can be reduced or even avoided.

Further, the elastic strips in the above mentioned press pump is further provided so that in case twist or deflection occurs, the elastic strips can contact with the inner wall during the process of being pressed down and before reaching the lower dead center, such contact with the inner wall will apply a push force to the elastic strips to restore them, thus realizing automatic correction.

In a specific structure, the elastic reset mechanism further includes an upper supporting ring, to which upper ends of the elastic strips are connected, the upper supporting ring being supported on or connected to the press head. In addition, alternatively or additionally, the elastic reset mechanism further includes a lower supporting ring, to which lower ends of the elastic strips are connected, the lower supporting ring being supported on or connected to the toothed sleeve.

Preferably, it can includes two elastic strips. Wherein, a connecting line between the upper supporting points on the supporting ring of the two elastic strips extends through a center of the upper supporting ring. Similarly, a connecting line between the supporting points on the lower supporting ring of the two elastic strips extends through a center of the lower supporting ring.

In one case, the upper supporting ring is rotatable with respect to the upper supporting ring, and the lower supporting ring is rotatable with respect to the toothed sleeve. At this time, when the press head is pressed so that the elastic reset mechanism deforms, the elastic reset mechanism may be twisted.

In another case, a first mating portion is formed on the upper supporting ring and/or lower supporting ring, and a second mating portion is formed on the piston rod, when the elastic reset mechanism is assembled together with the press head and the piston rod, the first mating portion and the second mating portion engage with each other, forming a synchronous structure. Thus, the upper supporting ring and the lower supporting ring can rotate synchronously with the press head and the piston rod, thus substantially no twist will occur, but deflection is possible.

In a specific structure, one of the first mating portion and the second mating portion is a groove, and the other of the first mating portion and the second mating portion is a rib extending axially along the piston rod.

In another specific structure, the first mating portion is a hole with interior gear, and the second mating portion is a shaft with exterior gear.

### THE BRIEF DESCRIPTION OF THE DRAWINGS

Embodiments of the present invention can be understood better from the structure shown in the attached drawings, wherein,

FIG. 1a is a cutaway view of a press pump of the first embodiment of the present invention, in which the press pump shown is at its upper dead center of the stroke.

FIG. 1b is another cutaway view of the press pump shown in FIG. 1a, in which the press pump shown is in the process of being pressed.

FIG. 1c is yet another cutaway view of the press pump shown in FIG. 1a, in which the press pump shown is in its lower dead center of the stroke.

FIG. 2a is a cutaway view obtained along the line A-A of FIG. 1a.

FIG. 2b is a cutaway view obtained along the line B-B in FIG. 1b.

FIG. 2c is a cutaway view obtained along the line C-C in FIG. 1c.

FIG. 3 shows a cutaway view of a press head and a piston rod connected to the press head of the press pump shown in FIGS. 1a-1c.

FIG. 4 shows a cutaway view of a toothed sleeve of the press head shown in FIGS. 1a-1c.

FIG. 5a shows a front view of an elastic reset mechanism of the press head shown in FIGS. 1a-1c.

FIG. 5b shows a side view of the elastic reset mechanism shown in FIG. 5a.

FIG. 5c shows a perspective view of the elastic reset mechanism shown in FIG. 5a.

FIG. 6a shows another perspective view of the elastic reset mechanism shown in FIG. 5a, in which planes that the respective elastic strip deforms and connecting line between the pivot points are schematically shown.

FIG. 6a shows another perspective view of the elastic reset mechanism shown in FIG. 5a, in which planes that the respective elastic strip deforms and connecting line between the pivot points are schematically shown.

FIG. 7 shows a schematic perspective view of the elastic reset mechanism assembled together with the press head and the piston rod.

FIG. 8 shows a schematic perspective view of the elastic reset mechanism assembled together with the toothed sleeve.

FIG. 9 shows a perspective view of an elastic reset mechanism of the press pump of the second embodiment of the present invention.

FIG. 10 shows a front view of a press head and a piston rod of the press pump of the second embodiment of the present invention.

FIG. 11 shows a perspective view in which the elastic reset mechanism shown in FIG. 9 and the press head and piston rod shown in FIG. 10 are assembled together.

FIG. 12 shows a perspective view of an elastic reset mechanism of the press pump of the third embodiment of the present invention.

FIG. 13 shows a front view of a press head and a piston rod of the press pump of the third embodiment of the present invention.

FIG. 14 shows a perspective view in which the elastic reset mechanism shown in FIG. 12 and the press head and piston rod shown in FIG. 13 are assembled together.

### DETAILED DESCRIPTION

In order to facilitate in understanding the present invention, detailed description on the embodiments of the press pump of the present invention will be illustrated hereinafter with reference to the drawings. It shall be understood that the drawings only show the preferred embodiments of the present invention, and they shall not be understood as limitations on the scope of the present invention. One skilled in the art can obtain any obvious modifications, variations, equivalents based on the embodiments shown in the drawings, and in case of not conflicting with each other, the features in different embodiments described below can be combined with each other at will, and all of these combinations will fall in the scope of the present invention.

In the detailed description on the present invention below, the terms such as “upper”, “lower” etc., which indicate directions and orientations, are based on the conventional orientation of the press pump in its use state, as shown in the drawings, and it can be understood that in such situations as transportation, storage etc., the orientation of the press pump may be changed.

### First Embodiment

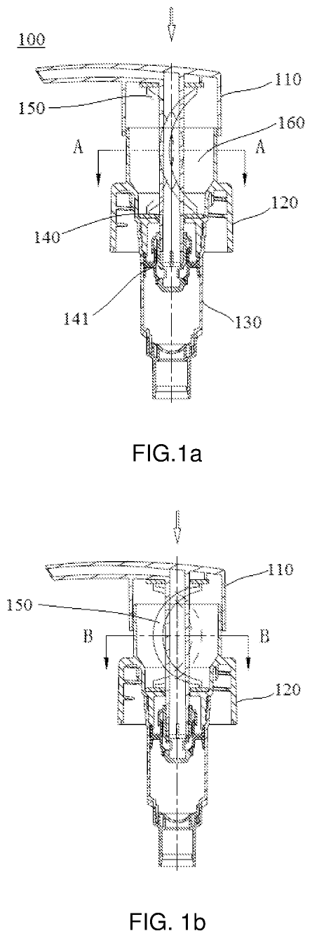

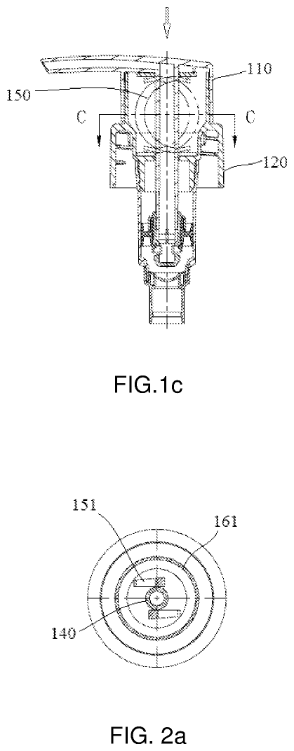

FIGS. 1-8 show a press pump 100 of the first embodiment of the present invention. Wherein, FIGS. 1a-1c show cutaway views of the press pump 100 in various states, in which the press pump 100 in FIG. 1c is at its upper dead center of the stroke, the press pump 100 in FIG. 1b is in its stoke of being pressed down and the press pump 100 in FIG. 1c is at its lower dead center of the stroke.

As shown in FIGS. 1a-1c, the press pump 100 includes a press head 110, a toothed sleeve 120 and a cylinder 130. The toothed sleeve 120 and the cylinder 130 are connected together. A piston rod 140 is provided below the press head 110, the piston rod 140 can be formed integrally below the press head 110 as shown in the drawings, or can be a separate part connected below the press head 110. A piston 141 is mounted on the piston rod 140, for example on the piston rod 140, for example the piston 141 can be mounted at or near a lower end of the piston rod 140. A portion of the piston rod 140 including the piston 141 (for example the lower end shown in the drawings) extends into interior space of the cylinder 130.

As shown in FIGS. 1a-1c, a lateral circumferential wall of the press head 220 cooperates with a lateral circumferential wall of the toothed sleeve 120 to form a reset mechanism containing cavity 160, in which an elastic reset mechanism 150 of the press pump 100 is contained. Specifically, the elastic reset mechanism 150 is supported between the press head 110 and the toothed sleeve 120, and is located around the piston rod 140.

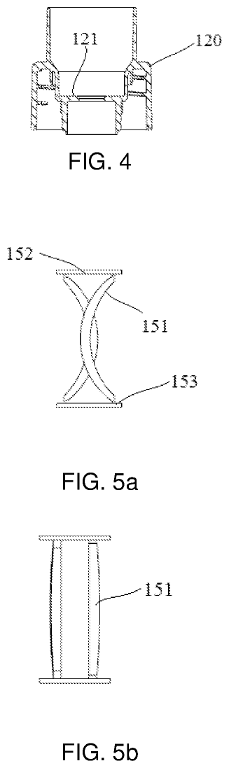

As shown in FIG. 3, the press head 110 includes a top inner surface 110, an upper end of the elastic reset mechanism 150 can abut against or be connected to the top inner surface 111. As shown in FIG. 4, a step 121 is provided within the toothed sleeve 120, a lower end of the elastic rest mechanism 150 can abut against or be connected to the step 121.

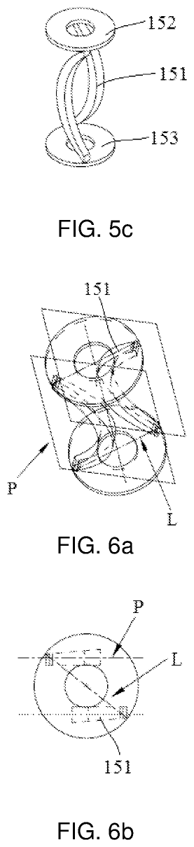

FIGS. 5a-5c respectively show front view, side view and perspective view of the elastic reset mechanism 150. The elastic reset mechanism 150 includes a plurality of elastic strips 151. In the preferred structure shown in the drawings, the elastic reset mechanism 150 includes two elastic strips 151. The planes in which the two elastic strips 151 respectively lie are preferably parallel to each other, as shown in FIG. 5b. Although the case of two elastic strips 151 is preferred, it can be contemplated that the elastic reset mechanism 150 can includes other number of elastic strips, which is more than two, for example three, four and so on, these cases are also included in the scope of the present invention.

Upper ends of the respective elastic strips 151 can be connected on an upper supporting ring 152, which is supported on the press head 110. Lower ends of the elastic strips 151 are connected on a lower supporting ring 153, which is supported on the elastic reset mechanism 150.

In other alternative structures, the upper supporting ring 152 can be omitted, so that the upper ends of the elastic strips 151 directly contact with or are connected to the press head 110. Or, the lower supporting ring 153 can be omitted, so that the lower ends of the elastic strips 151 directly contact with or are connected to the toothed sleeve 120.

In this application, the size and the structure of the elastic reset mechanism 150 is improved. In detail, as shown in FIG. 6a, the elastic strip 151 is in one deforming plane P. Further, when the elastic reset mechanism 150 is pressed to deform, in case that no twist or deflection occurs to the elastic reset mechanism 150, the elastic strip 151 is always elastically deformed in this deforming plane P. For example, the deformation of the elastic strips 151 in one plane can be obtained by arranging the elastic strips 151 to be symmetrical to each other with respect to the axis of the elastic reset mechanism 150.

Preferably, as can be more clearly seen from FIG. 6b, in the case of two elastic strips 151 provided, a connecting line between the pivot points of the two elastic strips 151 on the upper supporting ring 152 can extend through a center of the upper supporting ring 152. Similarly, a connecting line between the pivot points of the elastic strips 151 on the lower supporting ring 153 can also extends through a center of the lower supporting ring 153.

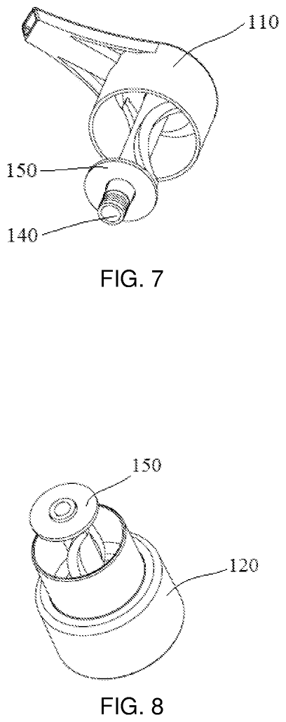

FIGS. 7 and 8 respectively show schematic perspective view of the elastic reset mechanism 150 assembled together with the press head 110 and the toothed sleeve 120. Wherein the upper supporting ring 152 of the elastic reset mechanism 150 supports on or is connected to a top inner surface 111 of the press head 110, and the lower supporting ring 153 of the elastic reset mechanism 150 supports on or is connected to a step 121 of the toothed sleeve 120.

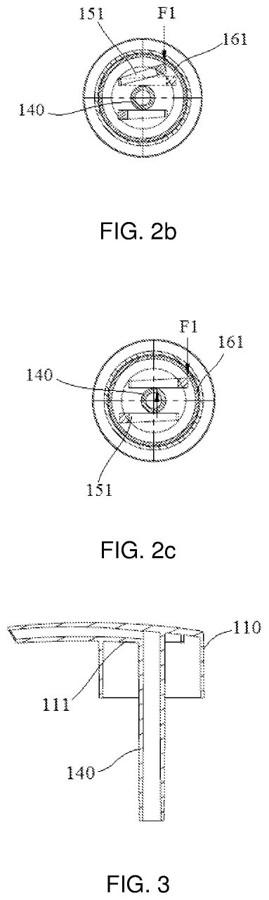

Further, as shown in FIG. 2a, the elastic strips 151 are disposed in close proximity to the piston rod 140. Also, the elastic strips 151 are sized so that when the elastic strips 151 are pressed down to deform, in case no twist or deflection occurs to the elastic reset mechanism 150, the elastic strips 151 is always free of contact with the inner wall 161 of the reset mechanism containing cavity 160 at least before the press head 110 is pressed to the lower dead center shown in FIG. 1c. In other words, the elastic strips 151 may be free of contact with the inner wall 161 during the whole pressing down stroke, including at the lower dead center of the stroke; or, the elastic strips 151 contact with the inner wall 161 only when the press head 110 just reaches its lower dead center of the stroke, and before that point, the elastic strips 151 is free of contact with the inner wall 161. Here, the inner wall 161 is consisted of at least one of the inner wall surface of the side circumferential wall of the press head 110 and the inner wall surface of the side circumferential wall of the toothed sleeve 120. Furthermore, if the elastic strips 151 twist during the process of being pressed down, the elastic strips 151 can contact with the inner wall 161 prior to reaching the lower dead center of the stroke. At this time, such contact between the inner wall 161 and the elastic strips 151 will apply a push force on the elastic strips 151, which pushes the elastic strip 151 to a position in close abutment with the piston rod 140, thus automatic correction occurs.

By means of the above mentioned detailed provision on the elastic reset mechanism 150, an automatic correction can be obtained for the twist of the elastic reset mechanism 150 during the process of being pressed down, thus a convert efficiency of the resilience of the elastic reset mechanism 150 can be improved. The principle of automatic correction for the elastic reset mechanism 150 of the press pump 100 of the present application will be explained in detail hereinafter.

FIG. 1a shows a press pump 100 in its upper dead center of the stroke, FIG. 2a is a cutaway view obtained along line A-A of FIG. 1a. Wherein, the elastic reset mechanism 150 is in its relaxed state, and its elastic strips 151 are in close proximity to the piston rod 140.

When it is needed to pump out the product in the container (not shown), a user presses down the press head 110 of the press pump 100, resulting in that the press head 110 moves downwardly, as shown in FIG. 1b. During the process of the press head moving downwardly, the elastic reset mechanism 150 is compressed. During the process that the elastic reset mechanism 150 is compressed, due to unevenness of the force applied, there will be relative rotation between the upper supporting ring 152 and the lower supporting ring 153 of the elastic reset mechanism 150, resulting in twist of the elastic reset mechanism 150. Here, unevenness of the force may result from various reasons, for example it is impossible for the user to apply press in a direction perfectly coincide with the axis of the press pump 100, and there is often a slight angle; for another example, the mass, degree of curve, density of the individual elastic strip 151 etc., may slightly varied, which results in difference in the amount of deformation and resilient produced when just one press force is applied; and so on.

Because of the twist of the elastic reset mechanism 150, at least one elastic strip 151 may disengage from the piston rod 140 and offset towards the inner wall 161 of the reset mechanism containing cavity 160, as shown in FIG. 2b. Wherein, FIG. 2b shows a cutaway view obtained along the line B-B in FIG. 1b. Thus, the elastic strip 151 will contact with the inner wall because of the twist of the elastic reset mechanism 150.

Continue pressing the press head 110 until reaching the lower dead center of the stroke of the press pump 100 shown in FIG. 1c. During this process, the elastic strip 151 leaves from the piston rod 140 and offsets towards the inner wall 161 of the reset mechanism containing cavity 160, as the press head 110 is further pressed down, both the amount of deformation and the amount of deflection of the elastic strips 151 will increase, thus resulting in contact with the inner wall 161. At this time, since the elastic strips 151 are sized so that it will always free of contact with the inner wall 161 when no twist or deflection occurs and the elastic strips 151 are in close proximity to the piston rod 140, when the elastic strips 151 contact the inner wall 161 because of twist or deflection of the elastic reset mechanism 150, the inner wall 161 will apply a correction force (or in other words push force) F1 on the elastic strips 151 towards the piston rod 140, so that the elastic strips 151 will return back in a direction towards the piston rod 140, as shown in FIG. 2c.

Thus, by means of the above mentioned provision in terms of the structure and the size of the elastic reset mechanism 150 of the present application, an automatic correction can be applied for the twist of the elastic reset mechanism 150.

Based on the above mentioned structure and principle of function, in the present application, the elastic strips 151 of the elastic reset mechanism 150 can be corrected to the state of deforming in the same plane and in close proximity to the piston rod, by means of providing the elastic strips 151 in such a way that in the process of being pressed, they are always free of contact with the inner wall 161 of the reset mechanism containing cavity 160 until reaching the lower dead center of the stroke, and thus a sound resilience converting efficiency of the elastic reset mechanism 150 can be obtained, its reset ability can be improved. And, by means of correction to the twist of the elastic reset mechanism 150, the service life of the elastic reset mechanism 150 can be prolonged.

### Second Embodiment

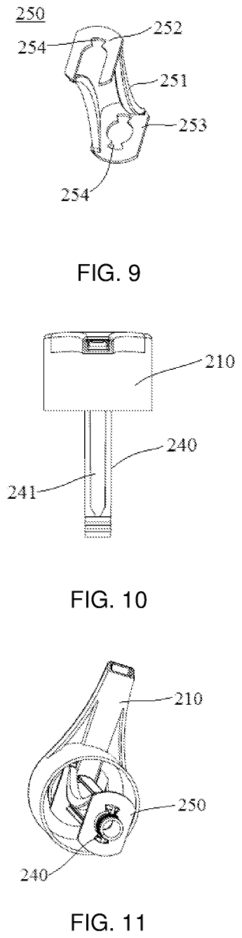

FIGS. 9-11 show a second embodiment of the present application, in which perspective views of the press head 210, the elastic reset mechanism 250 of the press pump, as well as their assembled state of the second embodiment are shown. In the following illustrations on the second embodiment, technical features of the second embodiment different from those of the first embodiment will be described in detail, and unless it is illustrated in contrary or conflicts with the other features, the features described in the first embodiment may also apply to the second embodiment, and will not be described in detail hereinafter.

As shown in FIG. 9, the elastic reset mechanism 250 of the press pump of the second embodiment includes a plurality of (two in the embodiment shown) elastic strips 251, the upper and lower ends of the elastic strips 251 respectively are connected to the upper supporting ring 252 and lower supporting ring 253. A first mating portion in the form of a notch 254 is provided on at least one of the upper supporting ring 252 and the lower supporting ring 253.

FIG. 10 shows a press head 210 of the press pump of the second embodiment. A piston rod 240 is connected below the press head 210, on an outer surface of which a second mating portion axially extending along the piston rod 240 is formed, the second mating portion is for example a rib 241 shown in the drawings.

When the elastic reset mechanism 250 and the press head 210 are assembled together, as shown in FIG. 11, the elastic reset mechanism 250 is sleeved onto the piston rod 240, and the notch 254 engages with the rib 241, forming a synchronous structure, which enables the upper supporting ring 252 and the lower supporting ring 253 of the synchronous structure to rotate synchronously, thus the elastic reset mechanism 250 can be free of twist.

However, in such a structure including a synchronous structure, because the press force applied on each elastic strip 251 of the elastic reset mechanism 250 may be uneven, or since some difference in terms of shape, density and so on produced due to manufacturing tolerance, the elastic reset mechanism 250 will be slightly deflected as a whole, so that the elastic strips 251 leave from the piston rod 240 and deflect towards the inner wall of the reset mechanism containing cavity, similar to the elastic strips 151 in FIGS. 2a-2c of the first embodiment. And, identically, the elastic strips 251 is also sized and shaped similarly to the elastic strips 151 of the first embodiment, so in the second embodiment, the deflection due to the elastic reset mechanism 250 will also be automatically corrected.

### Third Embodiment

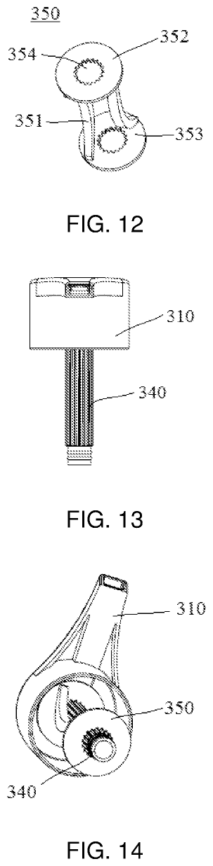

FIGS. 12-14 show a third embodiment of the present application, in which perspective views of the press head 310, the elastic reset mechanism 350 of the press pump, as well as their assembled state of the third embodiment are shown. In the following illustrations on the third embodiment, technical features of the third embodiment different from those of the first and second embodiments will be described in detail, and unless it is illustrated in contrary or conflicts with the other features, the features described in the first and second embodiments may also apply to the third embodiment, and will not described in detail hereinafter.

Similar to the press pump of the second embodiment, the press pump of the third embodiment also includes a synchronous structure. As shown in FIG. 12, the elastic reset mechanism 350 includes a plurality of elastic strips 351, upper ends of the elastic strips 351 are coupled to an upper supporting ring 352, lower ends thereof are coupled to a lower supporting ring 353, wherein a hole 354 with interior gear, as a first mating portion, is formed on at least one of the upper supporting ring 352 and the lower supporting ring 353. Correspondingly, as shown in FIG. 13, the piston rod 340 connected to the press head 310 is formed in the shape of a shaft with exterior gear.

When the elastic reset mechanism 350 is assembled together with the press head 310 and the piston rod 340, the piston rod 340 in the form of a shaft with exterior gear cooperates with the hole 354 with interior gear in the upper supporting ring 352 and the lower supporting ring 353 of the elastic reset mechanism 350 to form a synchronous mechanism, so that the elastic reset mechanism 350 is able to synchronously rotate with the press head 310 and the piston rod 340, thus no twist occurs.

However, similar to the second embodiment, the elastic reset mechanism 350 may deflect when subjected to a press force, and the structure of the press pump of the third embodiment identically has the ability of correcting such deflection, as described in relation to the second embodiment.

1. A press pump including a press head, a toothed sleeve and a cylinder, said toothed sleeve being connected to said cylinder, a piston rod being connected below said press head, a piston being mounted on said piston rod, a portion of said piston rod including said piston extending into interior of said cylinder;
wherein, a lateral circumferential wall of said press head cooperates with a lateral circumferential wall of said toothed sleeve to form a reset mechanism containing cavity, in which an elastic reset mechanism is contained, said elastic reset mechanism is supported between said press head and said toothed sleeve, and is provided around said piston rod, and
wherein said elastic reset mechanism includes at least two elastic strips, which are provided so that each elastic strip is located in close proximity to said piston rod; when said elastic reset mechanism is pressed to deform, in case that said elastic reset mechanism is not twisted or deflected, each elastic strip is elastically deformed in their respective deformation plane, and in case that said elastic reset mechanism is not twisted or deflected, said elastic strips are always free of contacting with inner wall of said reset mechanism containing cavity, at least prior to when said press head is pressed to its lower dead center of the stroke.

2. The press pump according to claim 1, wherein in case twist or deflection occurs to said elastic reset mechanism, said elastic strips can contact with said inner wall before said press head reaching the lower dead center of the stroke.

3. The press pump according to claim 1, wherein said elastic reset mechanism further includes:
an upper supporting ring, to which upper ends of said elastic strips are connected, said upper supporting ring being supported on or connected to said press head; and/or
a lower supporting ring, to which lower ends of said elastic strips are connected, said lower supporting ring being supported on or connected to said toothed sleeve.

4. The press pump according to claim 3, wherein it includes two said elastic strip, wherein a connecting line between pivot points on said upper supporting ring of such two said elastic strips extends through a center of said upper supporting ring; and/or
a connecting line between pivot points on said lower supporting ring of such two said elastic strips extends through a center of said lower supporting ring.

5. The press pump according to claim 3, wherein said upper supporting ring is rotatable with respect to said press head; and/or
said lower supporting ring is rotatable with respect to said toothed sleeve.

6. The press pump according to claim 3, wherein a first mating portion is formed on said upper supporting ring and/or said lower supporting ring, and a second mating portion is formed on said piston rod, when said elastic reset mechanism is assembled together with said press head and said piston rod, said first mating portion and said second mating portion cooperate with each other, forming a synchronous structure.

7. The press pump according to claim 6, wherein one of said first mating portion and said second mating portion is a notch, and the other of said first mating portion and said second mating portion is a rib extending axially along said piston rod.

8. The press pump according to claim 6, wherein said first mating portion is a hole with interior gear, and said second mating portion is a shaft with exterior gear.

9. The press pump according to claim 2, wherein said elastic reset mechanism further includes:
an upper supporting ring, to which upper ends of said elastic strips are connected, said upper supporting ring being supported on or connected to said press head; and/or
a lower supporting ring, to which lower ends of said elastic strips are connected, said lower supporting ring being supported on or connected to said toothed sleeve.
